(19) United States
(12) Patent Application Publication
(10) Pub. No.: US 2003/0055812 A1
(43) Pub. Date: Mar. 20, 2003

(54) Vehicle parts monitoring system and associated method

(75) Inventors: Tony Williams, Greenville, DE (US); Paul Williams, Royersford, PA (US)

Correspondence Address: Daniel H. Golub, Morgan, Lewis & Bockius LLP, 1701 Market Street, Philadelphia, PA, 19103-2921, US

(73) Assignee: Xccelerator Technologies, Inc.

(21) Appl. No.: 10/036,112

(22) Filed: Nov. 7, 2001

Related U.S. Application Data
(60) Provisional application No. 60/322,122, filed on Sep. 14, 2001.

(51) Int. Cl. G06F 7/00

(52) U.S. Cl. 707/1

(57) ABSTRACT

A graphical user interface comprising a tabular display and a tabular database. A user can access information from the tabular database. The tabular database is configured to store data relating to a vehicle system/group category table, a vehicle part category table, and a unique vehicle part identifier table, wherein the vehicle part category table is linked to the vehicle system/group category table and the unique vehicle part identifier table is linked to the vehicle part category table. Data for a prescribed part corresponding to the vehicle system/group category table, the vehicle part category table, and the unique vehicle part identifier table are displayed within the tabular display along a single row.

### CROSS REFERENCE TO CO-PENDING APPLICATION

This application claims priority to the U.S. Provisional Application filed Sep. 14, 2001, serial No. 60/322,122, by inventors Tony Williams and Paul Williams entitled “VEHICLE PARTS MONITORING SYSTEM AND ASSOCIATED METHOD”.

### FIELD OF THE INVENTION

This invention relates to a parts monitoring system, and more particularly to a vehicle parts monitoring system.

### BACKGROUND OF THE INVENTION

As certain as automobiles, planes, ships, helicopters, trucks, busses, tanks, and other vehicles initially work the parts and assemblies of these vehicles will degrade during use, damage, or abuse. This basic principle applies whether the vehicle is intended to drive on land, fly through the air, or travel through the water. This principle also applies whether the vehicle is a personal, a commercial, or a military vehicle.

Parts can be redesigned either because of a basic change in vehicle design, such as frequently occurs with automobiles, or to upgrade certain components because of serviceability or cost considerations. In any case, there can be multiple redesigns over the years for the same basic part.

The after parts market and used parts market for vehicles are extremely large. The profits that can be generated for after-market parts over the life of a vehicle, for example, often exceed the profits that can be realized by the original vehicle manufacturer the original sale of the vehicle. For example, replacement engine for most personal automobiles typically costs many thousand dollars. Authentic parts (i.e., a part that has the same part number as the original part) are those parts that are manufactured to the same standards and configurations as the original parts and under the control of the original vehicle and/or parts manufacturer. Using authentic parts and assemblies for repair or replacement ensures similar wear and operation as the original parts. Non-authentic parts are often designed to lower standards, and thus may not wear in the vehicle as well as authentic parts. Certain non-authentic parts are often referred to as “pirate” or “gypsy” parts. Though man non-authentic parts are also produced to high standards and of high quality materials, in extreme cases, non-authentic parts do not even work.

Another expanding area for replacement parts is restoration of vintage vehicles. For example, in 2000, one particular vintage 1964 Ferrari™ GTO automobile sold for 11 million dollars! A major contributor to the value of this automobile was the authenticity of its parts. Using authentic parts in a vintage vehicle maintains the maximum value for the vehicle and ensures the wear of the part as originally designed for the vehicle. Using non-authentic parts may considerably reduce the value of a vintage automobile. It is very challenging to prove which parts in a restored or repaired vehicle carry an authentic part number.

The most reliable and complete parts inventory catalogs in the automobile industry are found in hardcover bound volumes. The present method of proving which parts are authentic typically involves either manual or electronic cataloging of authentic parts and assemblies. The multiple catalogs that cover all the parts for a single make, model, and year of vehicle may take up many feet of shelf space. The size and expense of these catalogs may limit the number of vehicles for which a service center has catalogs, may result in the service center not having a complete set of catalogs for any one vehicle, and may mean that the information in the catalogs that the service center does have is out of date. Consequently, each dealer or repair shop may not have the necessary catalogs for all the vehicles they service. The process of identifying an authentic part often involves cross-referencing parts in different sections of the same catalog or multiple catalogs. This part identification process can be laborious and time consuming. Additionally, many catalogs contain a considerable amount of incorrect information (e.g., omission, exclusion of superceded parts information, etc.) since the input process for the catalogs is also laborious and time consuming. This incorrect information can result in confusion, frustration, wasted time, and added expense.

There are vehicle parts cataloging systems used in the automobile industry that rely largely on microfiche and similar technology. Such electronic vehicle parts cataloging systems are typically limited in the amount of data they contain. Additionally, cross-referencing parts in a microfiche vehicle parts cataloging system can be almost impossible since there is no search mode within microfiche technology.

Currently, there are parts inventory cataloging systems that store data in electronic format in which a cross reference between an original equipment manufacturer (OEM) part number and another reference number is supplied. These electronic inventory systems seldom contain full information, are only available to dealers, and generally contain information only for more recent vehicles. Such electronic inventory systems do not include the engineering drawings or detailed specification information included in the manual catalogs and vehicle brochures. In cases where “superseded by” parts information is included in electronic inventory systems, it is seldom cross referenced to any intermediate “superseded by” parts or, indeed, any of the engineering drawings or specifications from which that information could be reconstructed. These electronic inventory systems seldom indicate a superseding part number when the original part is discontinued, or contain an interchangeability field that would identify which parts can be used across a range of years or models of vehicles.

It would therefore be desirable to provide a computerized vehicle part and assembly cataloging system that includes a large amount of the information included in traditional catalogs, engineering drawings, specifications, and/or other sources. The cataloging system should have the capability to quickly cross reference between parts to allow the user to accurately access information about authentic parts. It would also be desirable to provide a system that can cross-check between multiple catalogs for inconsistencies.

### SUMMARY OF THE INVENTION

This invention relates to a graphical user interface comprising a tabular display and a tabular database. A user can access information from the tabular database. The tabular database is configured to store data relating to a vehicle system/group category table, a vehicle part category table, and a unique vehicle part identifier table, wherein the vehicle part category table is linked to the vehicle system/group category table and the unique vehicle part identifier table is linked to the vehicle part category table. Data for a prescribed part corresponding to the vehicle system/group category table, the vehicle part category table, and the unique vehicle part identifier table are displayed within the tabular display along a single row.

### BRIEF DESCRIPTION OF THE DRAWINGS

The accompanying drawings, which are incorporated in and constitute part of this specification, illustrate the presently preferred embodiment of the invention, and, together with the general description given above and the detailed description given below, serve to explain features of the invention.

FIG. 1 shows one embodiment of a vehicle parts monitoring system;

FIG. 2 shows another embodiment of a vehicle parts monitoring system;

FIG. 3 shows one embodiment of a graphical user interface (GUI) as applied to one embodiment of the vehicle parts monitoring system as shown in either FIG. 1 or 2;

FIG. 4 shows an alternate embodiment of the GUI that is applied to an assembly (e.g., an engine) instead of a vehicle as shown in FIG. 3;

FIG. 5 shows one embodiment of a relational model utilizing a body of relational database as provided by the vehicle parts monitoring system as shown in FIG. 1 or 2;

FIG. 6, including FIGS. 6A to 6F, illustrate multiple embodiments of windows that appear on the GUI of the vehicle monitoring system shown in FIG. 3 when a particular field or icon is selected; and

FIG. 7 shows one embodiment of a categories menu that is selected when the select category field in the GU shown in FIG. 3 is selected.

Throughout the figures, the same reference numerals and characters are used, unless otherwise stated, to denote like features, elements, components or portions of the illustrated embodiments.

### DETAILED DESCRIPTION OF THE EMBODIMENT

A vehicle parts monitoring system 100 that contains a substantially complete, accessible, and accurate list of parts is described. The vehicle parts monitoring system can be used by a variety of users. Vehicle and parts manufactuers can use the vehicle and parts manufactuers can use the vehicle parts manufacturing system to monitor their parts and detmine the identity of authentic parts. Vehicle owners can use the vehicle parts monitoring system to provide information on their vehicle and provide repair histories on their vehicle. Repar facilities can use the vehicle parts monitoring system to review the repair procedure for the vehilc ethat they are repairing. An individual desiring to ascertain the authenticity of parts in a vehilce can use the vehilce parts monitoring system to cmpare actual part numbers to part numbers of authentic parts. In brief, the vehicle parts monitoring system can be utilized by a wide variety of end users for a wide variety of purposes.

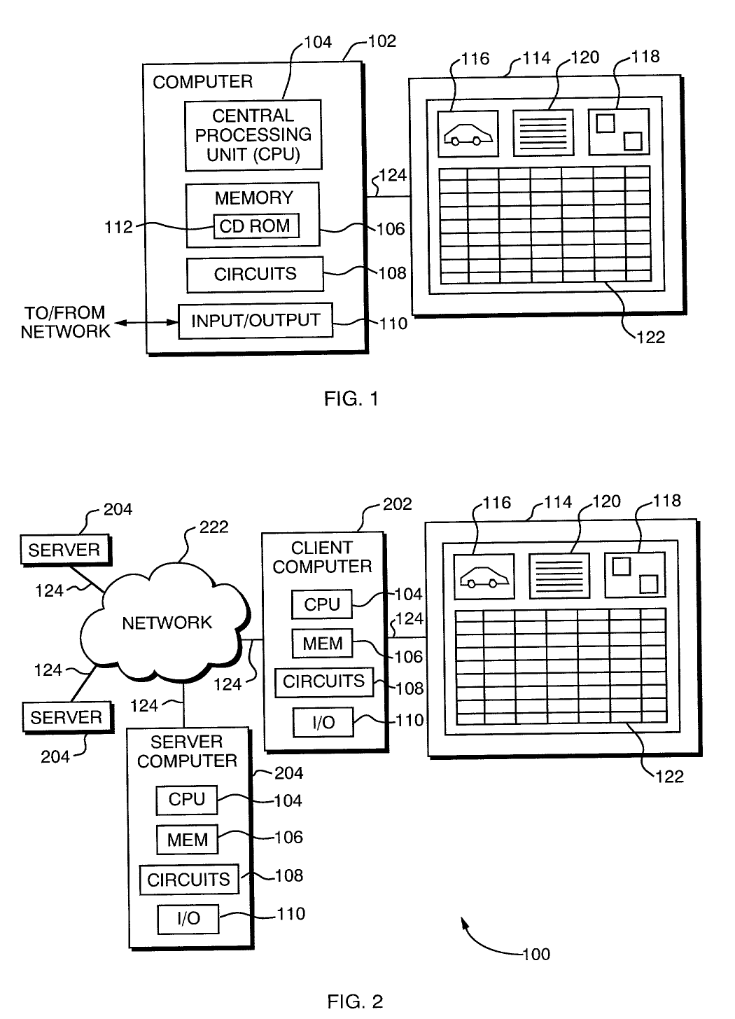

FIGS. 1 and 2 show two embodiments of a vehicle parts monitoring system 100. The embodiment of vehicle parts monitoring system 100 shown in FIG. 1 relies largely on compact disc (CD) technology. By comparison, the embodiment of vehicle parts monitoring system 100 shown in FIG. 2 relies upon network technology, such as the Internet.

The embodiment of vehicle parts monitoring system 100 shown in FIG. 1 includes a computer 102 and a graphical user interface (GUI) display 114. The computer 102 and the GUI display window 114 are connected by an inter-component electrical connector 124. The computer 102 includes a central processing unit (CPU) 104, a memory 106, a plurality of circuits 108, and an input/output (I/O) portion 110. The GUI display 114 includes a vehicle/part window 116, a billboard window 118, an information window 120, and a relational database parts display window 122. The memory 106 stores data relating to the vehicle parts monitoring system in an accessible format. It can be displayed over the GUI display 114, and thereby, is included in a database. One embodiment of the memory 106 includes a compact disc read only memory (CD ROM) 112. Although the memory 106 is indicated with the CD-ROM 112, it is envisioned that certain versions of random access memory and other versions of read only memory can also be included in the memory 106. For example, the user may wish to input data into the memory 106 relating to service performed on a vehicle or parts of a vehicle. Such information could be entered by the user in the form of notes.

The vehicle parts monitoring system 100 can be employed in a system that is controlled by a computer 102 that is preferably processor-based in that the I/O 110 of the computer 102 controls the operation of the vehicle parts monitoring system 100. The I/O circuits 110 is well-known, and is configured to generally operate as a power or I/O 110 supply, clock, cache, display, and the like. The I/O 110, for example, is capable of receiving electrical signals from temperature sensors and/or meters for monitoring parameters such as temperature, optical wavelength, light intensity, device characteristics, pressure, and the like. The elements 104, 106, 108, 110 are coupled to a control system bus to provide for communication between these other elements in the computer 102 and external elements.

The memory 106 contains instructions that the CPU 104 executes to monitor the processing of the parts information. The instructions in the memory 106 are in the form of program code. The program code may conform to any one of a number of different programming languages. For example, the program code can be written in C, C++, BASIC, Pascal, or anyone of a number of other languages. Additionally, the computer 102 can be fashioned as an application-specific integrated circuit (ASIC) to provide for quicker operating speed.

FIG. 2 shows an embodiment of the vehicle parts monitoring system 100 utilizing a network configuration, as opposed to the stand-alone computer configuration as shown in FIG. 1. In FIG. 2, the CPU 104, memory 106, circuits 108 and I/O 110 are shown in both a client computer 202 and a server computer 204 in order to demonstrate that the functions performed by these elements can be included in either the client computer 202, the server computer 204, or alternatively, other portions of network 222. The information relating to the vehicle parts monitoring system 100 can be stored in the client computer 202, the server computer 206, or at some remote location within the network 222. Distributed processing and networking techniques allow for data to be stored in one or more of these locations.

The embodiment of the vehicle parts monitoring system 100 shown in FIG. 2 includes the GUI display 114, the client computer 202, the network 222, and the server computer 204. The client computer 202 is attached to the GUI display 114 by the inter-component electrical connector 124. The client computer 202 and the server computer 204 are connected to the network 222 by an inter-component electrical connector 124. Though each of these different components 204, 222, 202 and 114 is attached to another component by an inter-component electrical connector 124, it is emphasized that these are distinct inter-component electrical connectors 124, not the same electrical connectors, and that certain of the different components may be structurally merged. Multiple server computers 204 are shown in communication with the network 222 in FIG. 2. The network 222 may be fashioned as the Internet, a corporate intranet, a wide area network, a local area network, or any other such network. Most particularly, in this discussion, it is assumed that the network 222 is the Internet. The client computer 202, the network 222, and the server computer 204 combine to form a database that is accessed by the GUI display 114. The database provides the data for the vehicle parts monitoring system 100. The embodiment of the vehicle parts monitoring system 100 shown in FIG. 2 is applied to a web site. Thus the vehicle parts monitoring system 100 can build on the technology of the Internet and/or a CD-ROM.

There may be certain benefits to the different embodiments of the vehicle parts monitoring system 100, such as are shown in FIGS. 1 and 2. For example, the embodiment shown in FIG. 1 provides a high degree of portability and provides a quick and easy format with which the users can interface. The use of the CD-ROM 112 represents one embodiment of storage media, although the use of any other appropriate internal computer memory devices in the memory 106 is within the intended scope of this invention. The embodiment of the vehicle parts monitoring system shown in FIG. 2 provides for access to a larger body of information over the Internet or other such network. To convert the vehicle parts monitoring system 100 from the CD-ROM format embodiment shown in FIG. 1 to the network client/server format shown in FIG. 2, the information on the CD-ROM is loaded into the appropriate web site by service provider, or vehicle/part manufacturers. The entire body of manufacturing by data is therefore available to the users, owners, service personal, and/or manufacturers. Photographs, diagrams, and/or all of the other data relating to parts can be captured in the vehicle parts monitoring system 100 so that when the data is uploaded to the web. The user can easily and quickly view the data.

The memory 106 in the embodiments of the vehicle parts monitoring system 100 shown in FIGS. 1 and 2, in combination with the GUI display 114, may be utilized to provide a relational database. Examples of relational databases include SQL™, ACCESS™, DB2™, and other well-known products. The term relational as applied to databases pertains to tables. In a relational database, data can be displayed to the user in the form of one or more tables. A spreadsheet, for example, is in the form of a table. Relational databases are powerful because during data generation they require fewer assumptions about how the data are related or how the data can be extracted from the database. As a result, the same database can be viewed in many different ways or by using different views. An important feature of relational database systems is that a single database can be spread across several tables. The tables can be reconfigured as desired by the database programmers by applying structured queries, or searches, to the data contained in the database. Data generated in response to a query will be displayed to the user in tabular form. When a different query is subsequently applied to the data in the relational database, the table, or tables, displayed to the user will be modified accordingly.

One embodiment of the vehicle parts monitoring system 100 captures the information relating to a particular vehicle (which information contain vehicle data that may have originated from many different places and may be in many different forms) into a single computer system. The vehicle parts monitoring system 100 captures the different pieces of information and assembles them into one database that can be accessed by a user over a graphical user interface (GUI). This embodiment of vehicle monitoring system 100 provides sufficiently accurate information to ensure that the user has access to authentic parts, such as engines, body parts, assemblies, etc., if the user thus desires. The vehicle parts monitoring system 100 provides rapid searching capabilities to a large database of vehicle parts information, thereby limiting minimizing, or eliminating, the time a service person or vehicle owner has to spend access a traditional vehicle cataloging system (that typically includes a large number of voluminous paper catalogs and/or electronic catalogs).

Vehicles are becoming more complex. Each vehicle such as a car, truck, plane, helicopter or boat requires an immense number of parts and assemblies produced by a large number of parts manufacturers. The fact that a vehicle was manufactured by a specific vehicle manufacturer does not mean that every single part of that car came from that manufacturer. For example, the Moog™ Company produces ball joints and other components for General Motors™ vehicles. As such, Moog manufactures many parts that are to be integrated into many models of General Motors cars and trucks. However, the springs for a General Motors car may another parts manufacturer, e.g., Eden. Spark plugs for TM General Motors cars may also be manufactured by parts manufacturers such as AutoLite™ or Motorcraft™. Other vehicle manufacturers have similar relationships with their major parts manufacturers.

When a user of the vehicle parts monitoring system 100 clicks on, e.g. the spark plug or a specific vehicle, the GUI 114 will display the manufacturer of that spark plug in addition to the vehicle manufacturer. It is important for the user of the vehicle parts monitoring system 100 to be able to determine the present manufacturer of every single part of a particular vehicle. The vehicle parts monitoring system includes parts data, parts specifications, parts assembly drawings, parts assembly notes, and other such information in digital format. Some of the parts information can be read, searched, modified, or added to by the user using standard CD-ROM as read/write technology in FIG. 1 embodiment, or by using server memory technology as in the FIG. 2 embodiment.

It is desired to integrate as much data as possible within the vehicle parts monitoring system 100 in the form of text data files to facilitate searching for parts information. For example, much of the text relating to older cars is in the form of assembly drawings that can be scanned into the vehicle parts monitoring system 100 as data. Known optical character recognition programs can be integrated as software within computers 102, 202, and/or 204 which can convert the drawing text into text data files that can be searched. As such, if a particular user is searching for all the assembly notes that relate to a part such as a tie rod, the user can search for the term “tie rod” using the vehicle parts monitoring system 100, and all the part data, engineering drawings, engineering specifications, etc., will be found in the search, regardless of the format of the drawing or sheet on which the text was originally located.

The vehicle parts monitoring system 100 includes a database that can be accessed to provide an enhanced product description of the parts, and the manufacturer of those parts in a particular vehicle (to the extent that the information is/was published by that manufacturer). Authentic parts are manufactured by an authorized parts manufacturer under the control of the vehicle manufacturer. In effect, an authentic part may be considered as being manufactured by the vehicle manufacturer.

There are a number of ways that the vehicle parts monitoring system 100 can be used. For example, in vintage vehicles number-matched vehicles are considered as those where most or all of the part, are authentic. Sometimes it is difficult to prove that a particular vehicle (such as an automobile) is a number-matched vehicle because it is difficult to prove which of its parts are authentic. One of the major challenges in proving whether a part is authentic involves determining the part number(s) of each part. If a person is restoring a particular number-matched vehicle, the vehicle parts monitoring system 100 is well worth its cost if the vehicle parts monitoring system 100 can prove which replacement part numbers match the authentic part numbers for that vehicle. In a number-matched vehicle, the vehicle parts monitoring system 100 can prove whether the parts were made by the vehicle manufacturer or an authentic parts manufacturer, and thus whether the parts were designed for that particular vehicle. A user considering whether to purchase that vehicle could use the vehicle parts monitoring system 100 to make sure that the vehicle has been restored using authentic parts. A potential user of the vehicle parts monitoring system 100 can therefore use the system to ensure authenticity of individual parts as well as parts subsequently installed in that vehicle.

The vehicle parts monitoring system 100 is also valuable as a service for relatively new vehicles. Newer vehicles typically have a larger number of parts, components, and assemblies compared to older vehicles, and many of the parts, components and assemblies in newer vehicles are more sophisticated and complex than those of older vehicles. For example, anti-lock brakes that are used in many newer automobiles and trucks are microprocessor based. As vehicles become more sophisticated, electronic, and complex, it is in turn becomes more important to ensure that the parts used in the repair of those vehicles are authentic to ensure proper interoperability among the parts. In more recent vintage vehicles, parts are from more suppliers (often located in many international companies) as compared to many older vehicles. The assembly drawings and specifications are even more complex in modern vehicles as a result of their added complexity and large assembly substructures. The vehicle parts monitoring system can use a variety of accepted technologies to access the data.

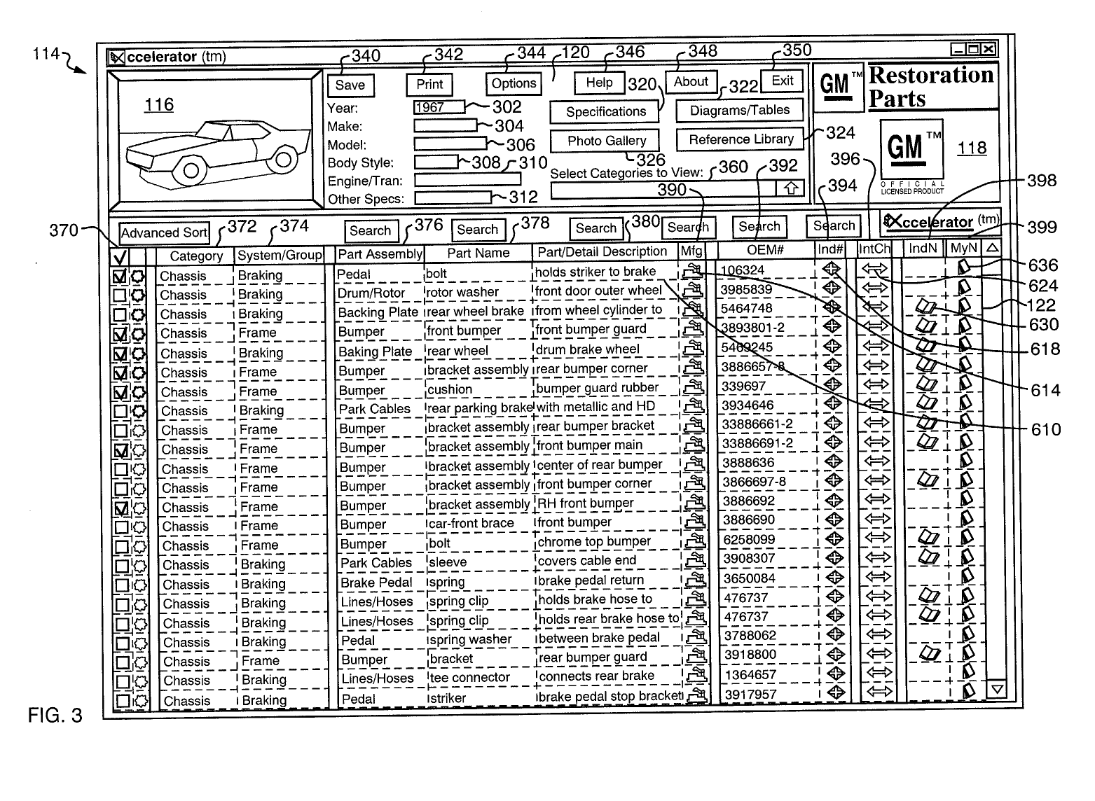

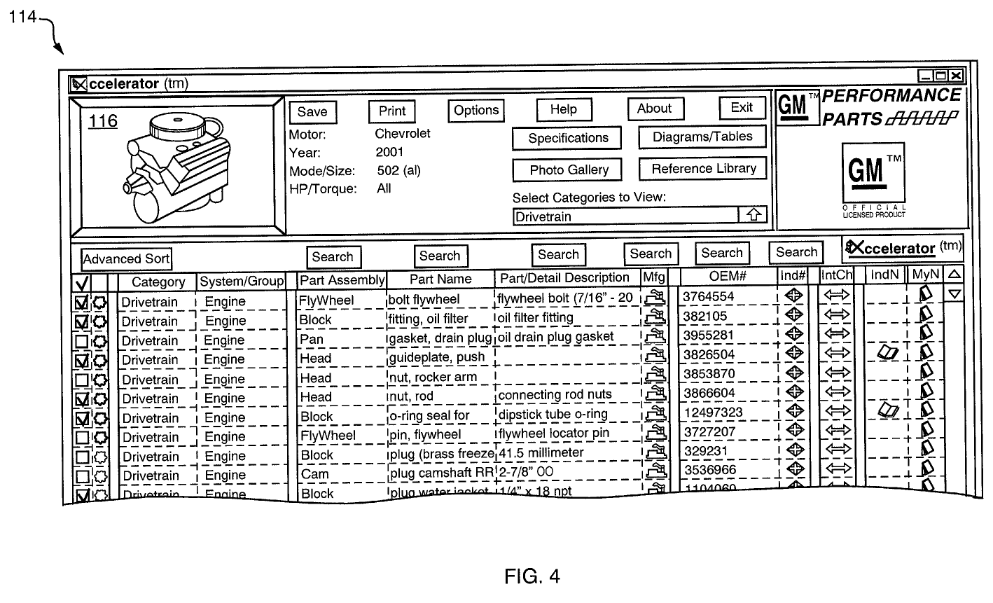

One embodiment of a graphical user interface 300 (GUI) that can be applied to the vehicle parts monitoring system 100 is shown in FIG. 3, in which an automobile is displayed in the vehicle window 116 of the GUI display 114. By comparison, FIG. 4 shows an embodiment of GUI display 114 devoted to parts or assemblies, where, for example, an engine is displayed in the parts window 116.

The GUI display 114 in FIG. 3 includes the vehicle window 116, an information window 120, a billboard window 118, and a relational database parts display window 122. The parts included in the relational database parts display window 122 correspond to the vehicle displayed in the vehicle window 116. For example, if a year 2000 Ford Mustang is displayed in the vehicle window 116, then all of the parts in the relational database parts display window 122 correspond to the year 2000 Ford Mustang. Thus, the data in the relational database parts display window 122 and the vehicle window 116 are limited. In this manner, a user of parts from a large number of vehicle/assemblies (such as part suppliers/dealers, etc.) would be continually when viewing the GUI 114 display of the vehicle class being displayed at the present moment within the relational database display window 122. Displaying the information in this manner thus minimizes the chance of confusion or mistakes in light of the large number of vehicles assemblies parts that are potentially available.

The information window 120 contains a variety of fields and information pertaining to the vehicle displayed in the vehicle window 116. For example, the information window 120 fields showing includes the year 302, the make 304, the model 306, the body style 308, the engine/transmission 310, and other specifications 312. Depending upon the vehicle displayed in the vehicle window 116, the pertinent information for the year 302, make 304, model 306, body style 308, engine transmission 310, other specifications and 312 fields will be displayed. Thus, the fields 302, 304, 306, 308, 310, and 312 provide a further reminder and confirmation of the particular vehicle to which the parts being displayed in the relational database parts display window 122 apply.

The information window 120 includes a specifications selection button 320, a photo gallery selection button 326, a diagrams/tables selection button 322, and a reference library selection button 324. The user, when viewing the GUI display 114 in the configuration of the vehicle parts monitoring system 100 shown in FIGS. 1 and 2, can view the specifications for the particular vehicle displayed in the vehicle window 116 by selecting the specification selection button 320. The user can also view a photo gallery of the vehicle displayed in the vehicle window 116, similar to that provided by the original manufacturer in the brochure issued the year the vehicle was manufactured, by selecting the photo gallery selection button 326. Similarly, the user of the vehicle parts monitoring system 100 can view applicable diagrams or tables of the vehicle displayed in the vehicle window 116 by selecting the diagram/tables selection buttons 322. Additionally, the user of the vehicle parts monitoring system 110 can be provided with a reference library associated with the vehicle displayed in the vehicle window 116 by selecting the reference library selection button 324. The reference library may contain other references relating to the vehicle.

The user of the vehicle parts monitoring system can perform typical window-type operations on the window appearing in the GUI display 114 by selecting a save button 340, a print button 342, an option button 344, a help button 346, an about button 348, or an exit button 350. The operation of buttons 340, 342, 344, 346, 348, and 350 are well known by window and GUI users, and will not be further described herein. Additionally, the information window 120 includes a select category to view a pull down menu 360 that display the categories to be displayed.

In a complex system such as an automobile, there is a need to sort the large number of parts that make up that vehicle into a few categories. Examples of such categories include, but are not limited to, chassis, drive train, interior, etc. To display all parts present in a particular category over the relational database parts windows 122, the user selects that appropriate category in the select category to view pull down menu 360. The relational database parts display window 122 can be considered as a relational view of the relational database of the vehicle parts monitoring system 100 shown in FIGS. 1 and 2.

The fields of the relational database parts display window 122 of the GUI display 114 are now described. All the information displayed on the relational database parts display window 122 of the GUI display 114 relates to a single vehicle or part. All the information relating to a part can be accessed on a single line (row) on the database. The columns included in the relational database parts display window 122 include the user selection column 370, the category column 372, the system/group column 374, the part assembly column 376, the part name column 378, the part/detailed description column 380, the manufacturing column 390, the original equipment manufacturer (OEM) number column 392, the industry reference number column 394, the interchangeability column 396, the industry notes column 398, and the my notes column 399. The original equipment manufacturer's (OEM) number is the part number assigned by the manufacturer of the vehicle, e.g., Chevrolet, Ford. Each row of the relational database parts display window relates to the entries pertaining to a single part.

The arrangement of the columns 370, 372, 374, 376, 380, 390, 392, 394, 396, 398, and 399 along a single line allows the user to access all the information pertaining to any part on the same GUI display 114. As such, the necessary cross-referencing links to access all the information about a particular part are limited. Any icon that is selected (e.g., as shown in columns 390, 394, 396, 398, and 399) will generate a pop-up window containing information relating to the selected part and column. The pop-up window will be displayed in a location that does not obstruct any other information in the row relating to that selected part. As such, even when the pop-up window is displayed, the information within the columns 370, 372, 374, 376, 380, 390, 392, 394, 396, 398 and 399 remains intact. This single-line display of the information pertaining to the selected part provides an intuitive and easy-to-access source of information relating to any desired part displayed on the GUI display 114.

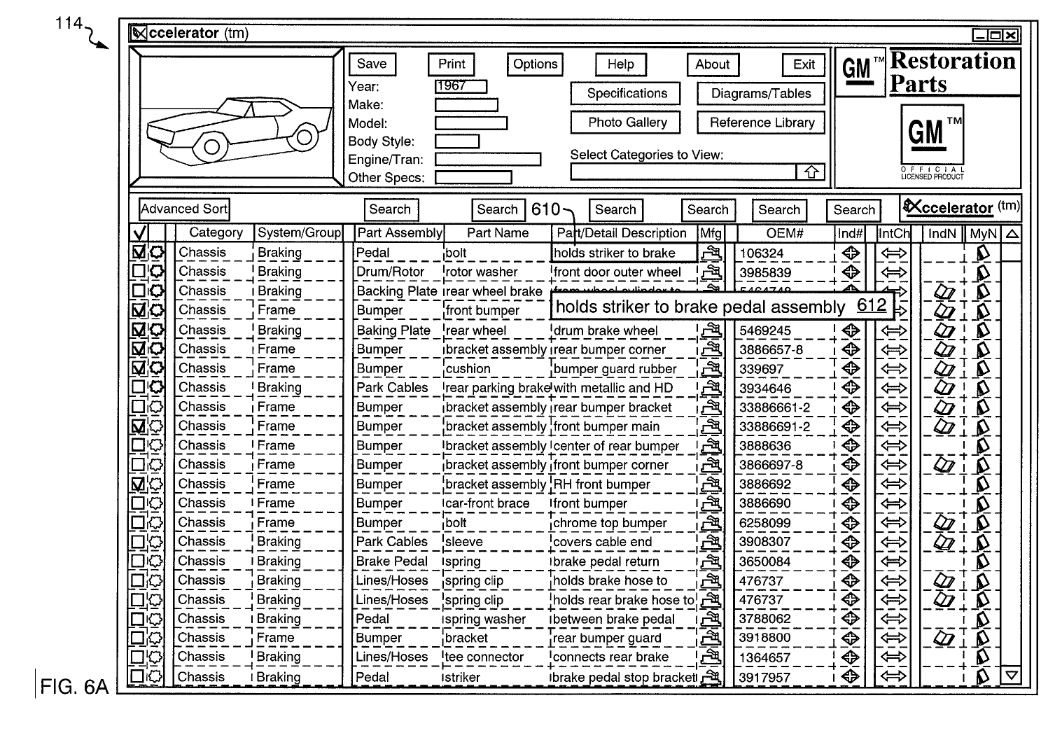

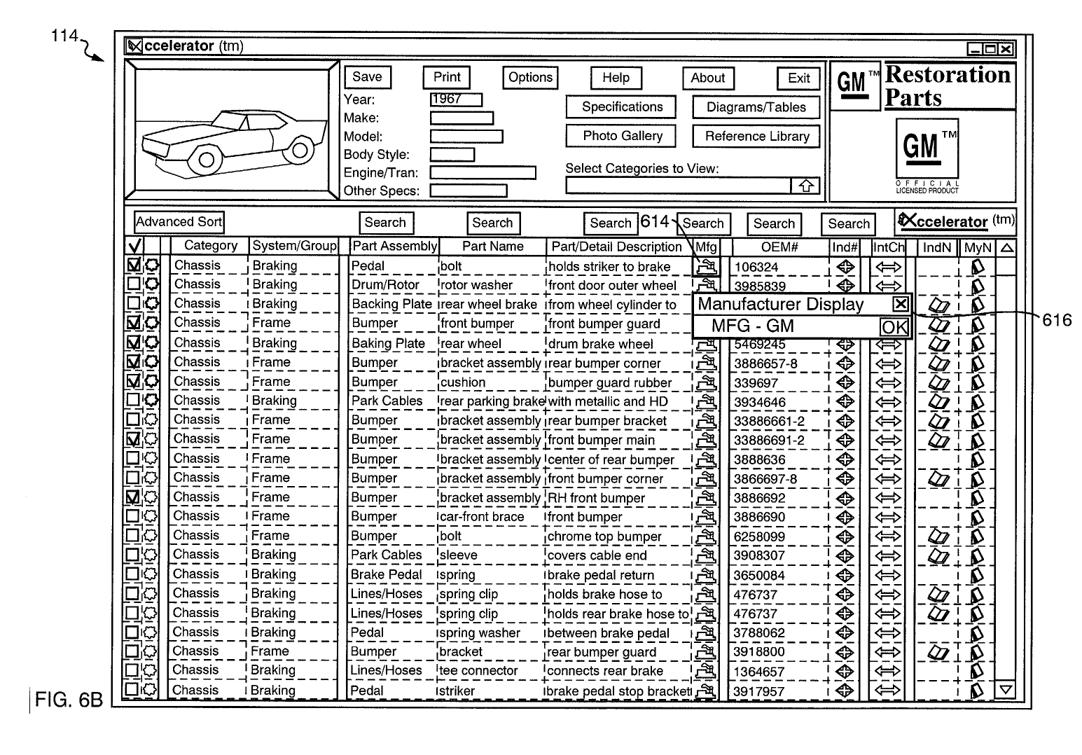

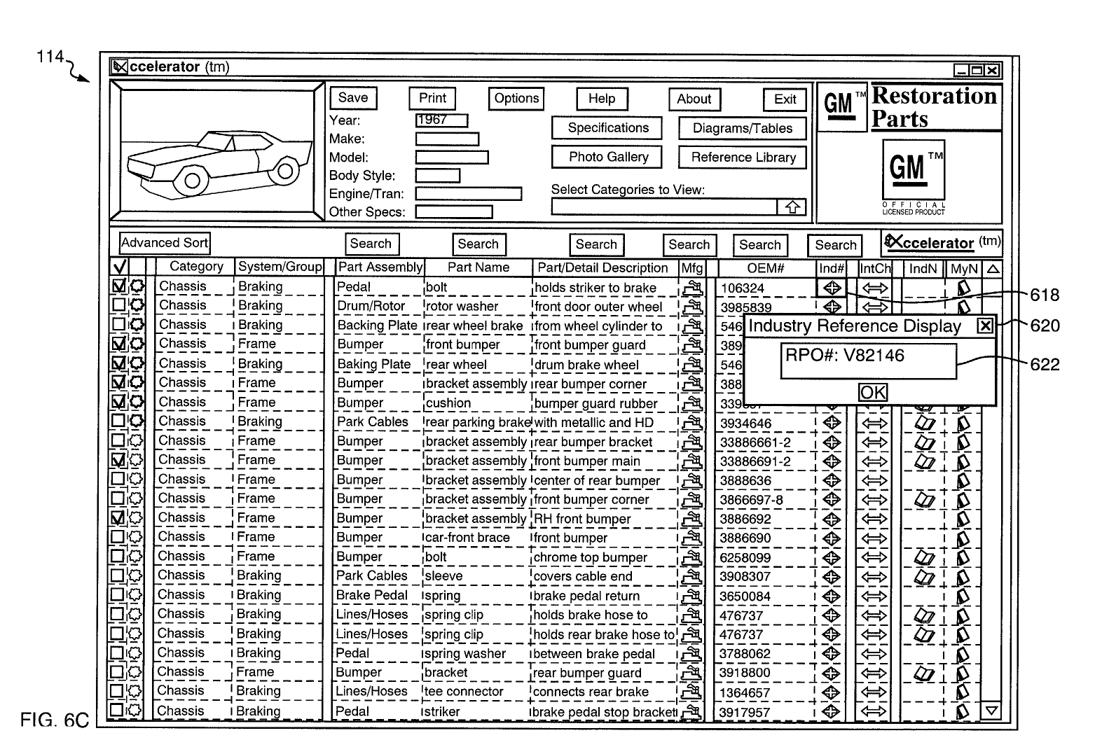

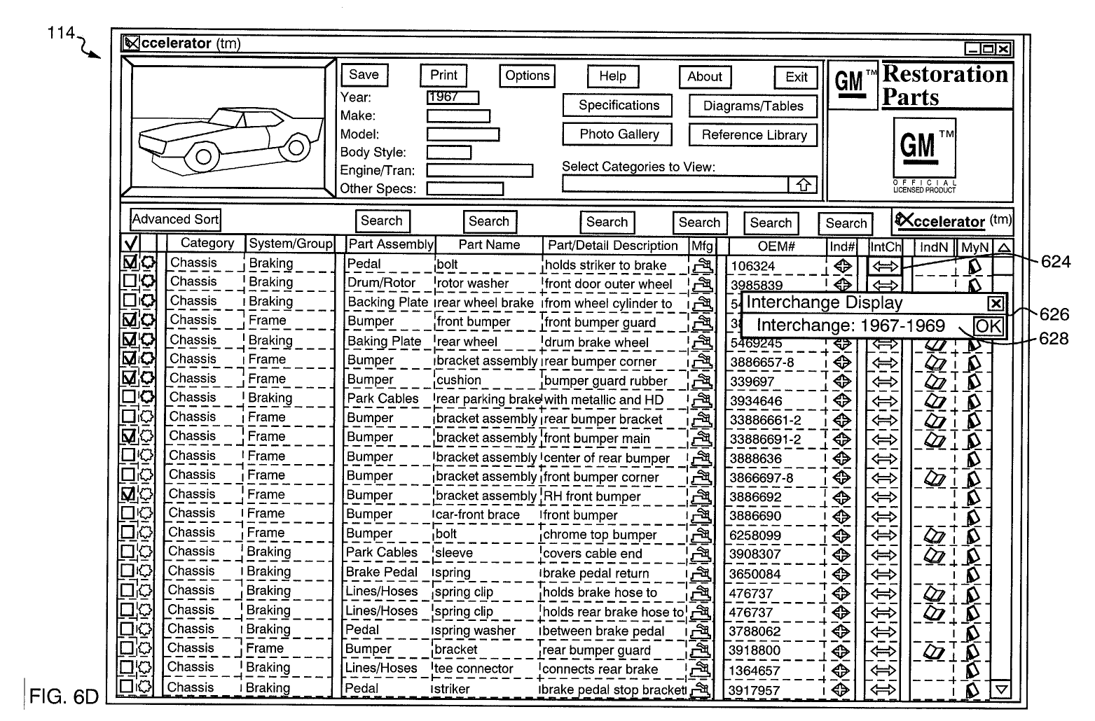

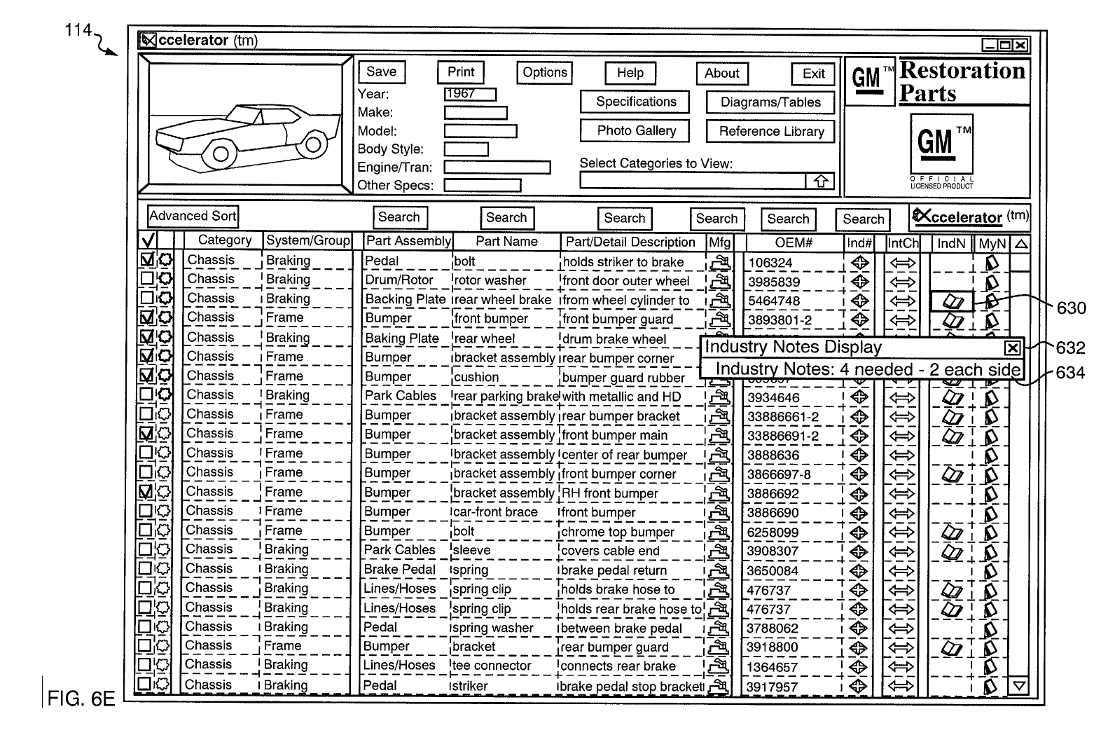

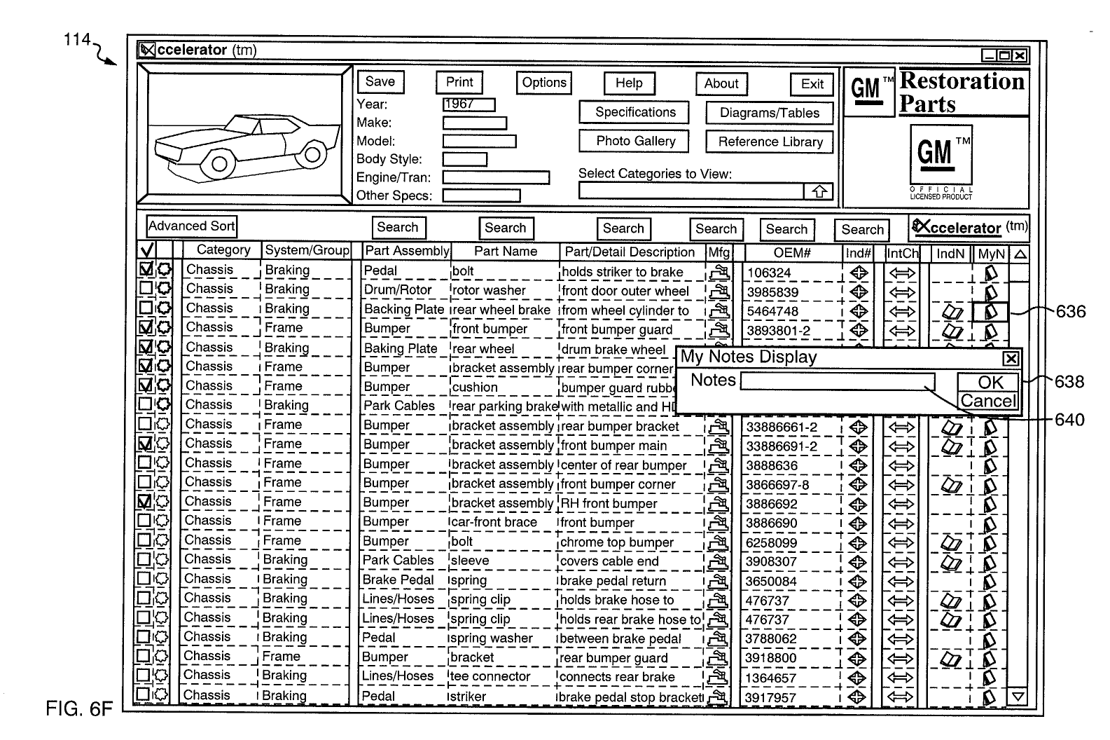

FIG. 6, that include FIGS. 6A to 6F, illustrates modifications to the embodiment of GUI display 114 shown in FIG. 3. FIG. 6 indicates how the GUI 114 of the vehicle monitoring system is able to display, and continue to display, a wide variety of information on a single line. Consider what happens to the embodiment of vehicle monitor system shown in FIG. 3 when different fields corresponding to particular parts are selected. Certain of the fields display no more information to than is already displayed in the relational database parts display window 122 since this the entire amount of information for that field is supplied by the parts or vehicle manufacturer, and is already displayed. For example, the category field 372, the systems/group field 374, the part assembly field 376, the part name field 378, and the OEM # field 392 contain all the information for those particular fields supplied by the part or vehicle manufacturer.

Certain other fields contain either more of greater detailed description or an icon that can be accessed to provide a greater amount of information. For example, if a user runs over the part/detail description column 380 in the first row displayed over the vehicle monitoring system (e.g., the pedal bolt) a drop-down window 612 would appear below the parts/detailed description field 610 as shown in FIG. 6A. The description would be embellished to say in windows 612, “hold striker to break pedal assembly” instead of the original statement of “hold striker to break” as contained in window 610. Other parts include even more detailed descriptions to limit ambiguity as to the part or function of the part.

As with each pop-up window (or other window) that arises in the GUI 114 when a field is selected, the pop-up window 616 does not obstruct the row corresponding to the parts selected by the user. As such, all the information relating to this part can be considered as being accessed, from a single line, and all of the information on the line continues to be displayed even as pup-up menus are opened.

If a user double clicks on the manufacturer field 390 shown in FIGS. 3 and 6B, then the manufacturer display pop-up window 616 appears. The contents of the manufacturer display pop-up window indicate the identity of the manufacturer of that particular part. In this instance, GM is listed in the pup-up window 616 as the manufacturer of the part.

Users can access the industry reference number field 394 for a particular part by clicking the icon in that column relating to that particular part. For example, if a user wanted to know the industry reference number for the first part listed in the GUI 114 in FIG. 3, then the user would select the icon in field 618. Selecting field 618 would result in displaying an industry reference pop-up window 620 as illustrated in FIG. 6C. The industry reference popup menu includes industry reference number 622. In this instance its RPO number: V821486.

When a user selects an icon in the interchangeability column 396 of the vehicle monitoring system, a list of years of vehicles for which the selected part is interchangeable is displayed. For example, assume that a user clicks on the interchangeability icon 624 as shown in FIGS. 3 and 6D. The interchange display pop-up window 626 pops up. The contents of the interchange pop-up window 626 include the interchange display field 628, which in this instance, indicates interchangeability of that part within similar vehicle in the years 1967 through 1969. As such, this part could be used in the same vehicle between those years.

If a user double clicks on the industry notes column 398 for a particular part, e.g., on the icon 630 displayed in FIGS. 3 and 6E, then the industry notes display pop-up window would appear as illustrated in FIG. 6E. Industry notes display pop-up window 632 indicates, for this particular backing plate, that four are needed, two on each side. These are notes that are supplied by the parts or vehicle manufacturers. As such, the owner or repair person would note these details when placing a repairing these individual parts. The individual notes are displayed in the industry notes display field 634.

The my notes column 399 includes whatever input the user desires to input themselves. For example, if user were to click on the my notes icon 636 for first part list in a vehicle parts monitoring system, as illustrated in FIGS. 3 and 6F, then the my notes display window 638 would pop-up as shown in FIG. 6F. The my notes display window includes a note field 640 that the user can use and input whatever information they want. The my notes field 640 can be as long as desired, and can alternatively be configured so that typing past this field link will result in the windows scrolling over in one direction or another. The user can also select certain fields in the select fields 370 as shown in FIG. 3, in a using a convention, known only to the user. For example, checkmark or a darkened field in the select column, mainly in an entirely different thing for known or other vehicle might indicate entirely different things to different users. This further indicates that the vehicle parts monitoring system may be utilized by a very large variety of end users performing a very large number of task.

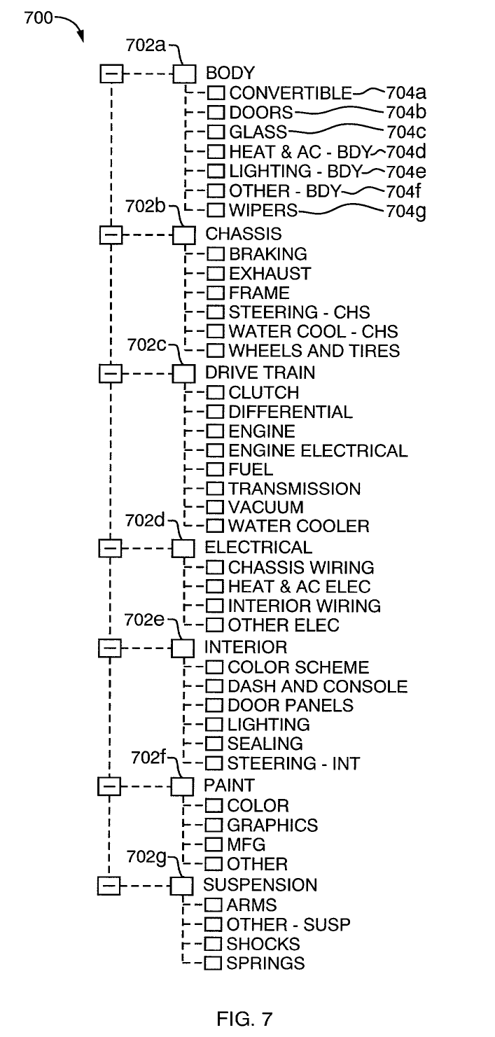

If user selected the select category to view 360 as shown in FIG. 3, then the categories menu 700 is shown in FIG. 7 would appear in a separate drop down window. The categories are selected by highlighting the appropriate category box, boxes 702a, 702b, 702c, 702d, 702e, 702f, and 702g. In this instance, the categories that are displayed include the body 702a, the chassis 702b, the driver train 702c, the electrical 702d, the interior 702e, the paint 702f, and the suspension 702g. Other categories can be selected. Each category is subdivided into sub categories. For example, the body category 702a includes a sub category, convertible subcategory 704a, a door subcategory 704b, a glass subcategory 704c, a heat and air conditioning body 704d, a lighting body 704e, and other-bodies 704f, and wipers subcategory 704g.

The user selection column 370 allows the user to select, or un-select, one or more columns for whatever purpose the user wishes. For example the user may wish to order several parts. The user thus checks those rows in the user selection column 370 relating to particularly those parts. The reason for selecting or un-selecting certain of the rows in the user selection column 370 is dependent upon the user.

The category column 372 describes the broad category to which the part belongs (e.g., a chassis as shown in FIG. 3). The system/group column 374 describes the particular system/group to which the particular part in the relational database parts display window 122 belongs. The part assembly column 376 contains the name of the subassembly as shown in the relational database parts display window 122. The part name column 378 shows the name of the particular part as shown in the relational database parts display window 122. Note that the descriptions in columns 372, 374, 376, 378 become increasing more specific to the particular part. For example, the first item in relational database parts display window 122 in FIG. 3 is a bolt that is part of the pedal assembly that is included in the braking system group that is categorized in the chassis.

The part/detailed description column 380 contains a more detailed description of each part contained in the relational database parts display window 122. For example, in the first row of FIG. 3, the part name is described in the part name column 378 as a bolt. It is likely that there are multiple bolts within the pedal assembly of the braking system group. As such, the part/detailed description column 380 allows the vehicle parts monitoring system 100 to provide a more complete description of the actual operation, position, structure, and dimensions of any individual parts that may not be contained in other columns. In this example, the bolt mentioned in the part name column 378 is described as the bolt that holds the striker to the brake in the part detailed description column. As such, the part/detailed description column 380 provides a more understandable description of that particular part.

The manufacturing column 390 identifies who manufactured each particular part in the relational database parts display window 122. The manufacturer may be the OEM vehicle manufacturer, or alternatively an approved manufacturer to whom the production of that part was outsourced. There may be more than one manufacturer for any one part, so it is desired in certain embodiments that the manufacturing column 390 be capable of providing a means for users to access all of the potential manufacturers for that particular part.

The OEM number column 392 contains the OEM number of the part. It may be desired to have the part renamed to contain the identifying information of the original equipment manufacturer part. For example, the OEM part may refer to a part that includes multiple subparts. This can cause of confusion in that an OEM number can refer either to one specific part or to an overall assembly which may, or may not, contain parts with their own OEM numbers. As such, an industry reference number column 394 is also provided. For example a bumper contains many individual parts such as front and/or back sections, springs, protective covering, etc., each of which has been assigned a distinctly different industry reference number. All of the part numbers for these subparts and assemblies can be accessed by selecting the industry reference number icon. When clicked on, this icon provides a popup window displaying all of the industry reference numbers pertaining to that particular part.

“Superseded” or upgraded parts can also be handled in different manners. In certain embodiments of the vehicle parts monitoring system 100, the industry reference number column 394 is automatically updated to reflect the latest new part number or the regular production option (RPO). If archived to memory 106, the older, superseded part numbers can also be recalled by clicking on the industry reference number column 394 (if no superseded part number is shown at all, it will mean that no superseded part exists, and that the RPO has always been in service). To be effective, the superseded information has to be updated constantly.

To explain certain aspects of the RPO number that are accessed from the industry reference number column 394, assume that the part being accessed by the vehicle parts monitoring system 100 is, e.g., a cylinder head for a car. The cylinder head has a standard identification called a casting ID. The casting ID is typically stamped on the cylinder head. The casting ID for many parts is important because it uniquely identifies the part number as well as the factory that produced the part. Consider that some parts (e.g., cylinder heads) for the same model of vehicle can be manufactured in different factories. These parts are manufactured to the same standards, dimensions, and tolerances in each of the different factories so that they can be used interchangeably in a given model of vehicle, but will still have different casting IDs for traceability purposes. As such, there can be multiple versions of the same RPO casting, each having a different casting ID.

The vehicle parts monitoring system 100 displays (as the RPO number in the pop-up window when the icon in the industry reference number column 394 is selected) the last superseded number by which the part was known. In addition, the vehicle parts monitoring system 100 displays the casting number (stamping number) as another way of identifying the part. Perhaps there are/were three or more factories producing the same part. The vehicle parts monitoring system 100 includes a complete list of casting IDs of all of the authentic parts produced by the different factories (provided that all of the parts have been catalogued). The vehicle parts monitoring system 100 provides a compilation of a plurality of, or all of, the casting IDs applied to the same part. The user can determine, using the vehicle parts monitoring system 100, any form of factory identification used to identify that part. In this manner, different part numbers corresponding to the same OEM number can be captured in the vehicle parts monitoring system 100.

The industry reference number column 394 is very useful for identifying not only standard parts, but also optional parts. Assume that a person bought a vehicle (e.g., a car) when it was new from a dealer with certain selected options. Further, suppose the purchaser selected variable-speed wipers, air-conditioning and other dealer options. Note that the dealer options are one type of RPO.

When the purchaser of a car selects a dealer option such as variable-speed wipers, the part number of that selected option is sent to the factory. In the vehicle parts monitoring system 100 there is a number associated with that option. When a particular car comes off an assembly line, the car is associated with a build sheet that indicates the dealer options for that car. The build sheet may actually be computerized as it is in recent manufacturing plants. The assembler obtains the information and part number from the build sheet, and picks the part out of the bin associated with that RPO number. The assembler then installs the selected option (e.g., variable-speed wipers) in the car. The assembler then checks this option off on the build sheet as completed. The same process is performed for all of the options selected for that car.

Customer-ordered option parts are therefore built into a vehicle using RPO numbers. These RPO numbers are integrated into the vehicle parts monitoring system 100, and the user may click on an RPO to select that particular part. The vehicle parts monitoring system 100 lists all the parts in the option bin that can be applied to that year/make/model of vehicle. Even the manufacturer often does not have this level of information corresponding to the RPO number for vehicles that are no longer being built.

The parts and vehicle manufacturer user list, sample list and RPO sheet are, for example three pages long for most vehicles because of the large number of options available to a purchaser. The vehicle parts monitoring system 100 keeps track of all of the parts used for the options as well as the standard parts. Therefore, the vehicle parts monitoring system 100 can be configured to store information relating to every single part that went into each vehicle in an easy-to-access format.

The vehicle parts monitoring system 100 is useful for persons involved in building and repairing vehicles. A consumer could use the vehicle parts monitoring system 100 if desiring to know whether a certain part was an option or an authentic part. The vehicle parts monitoring system 100 provides a means to determine that parts are authentic, and also to resolve questions as to the authenticity of the parts.

The RPO number can be accessed to indicate a collection of parts that are related to a particular category (e.g., the frame). The same RPO number might be cross-referenced in several different categories. A user could use the vehicle parts monitoring system 100 to access the RPO numbers just like a dealer does when a purchaser goes into the dealer. The purchaser can select options using the vehicle parts monitoring system 100. A user could take the RPO number, the RPO number that is obtained in a pop-up window when you select the checkmark associated with the that part.

The vehicle parts monitoring system 100 would be of interest to a number of potential users. This applies particularly to order style vehicles, in which the manual checking of voluminous catalogs can be very time intensive. An example would be repair shops, in which the tool can be used to replace parts or rebuild a car using authentic parts. A manufacturer might also have to use restoration parts, based on the availability of tooling. The quality of these restoration parts would be high as a result of having to meet stringent guidelines for the original tooling specification.

The interchangeability column 396 provides for an indication of the interchangeability of each part in the manufacturing column 390 with one or more parts having different industry reference numbers in the industry reference number column 394. Interchangeability as shown in column 396 represents the range of years for the make and model of vehicle which can use the same part. For example, certain authentic parts for a '67 Camaro would also be authentic parts for a '68 Camaro and/or a '66 Camaro. This is the standard for interchangeable parts. The vehicle parts monitoring system 100 displays the interchangeable parts, and thus provides a valuable piece of important information.

The industry notes column 398 provides the specific notes from the parts manufacturers to a user of the vehicle parts monitoring system 100. Such industry notes 398 may indicate, e.g., common difficulties with a particular part, and other information that may be of use to the user of the vehicle parts monitoring system 100.

The my notes column 399 provides a location by which the user (owner, service person, etc.) may provide notes relating to each individual parts. For example, a particular user may refer in the my notes column 399 to a part that was replaced or repaired. A user or repair person can insert their own notes in the vehicle parts monitoring system 100 in a form that follows the vehicle by typing in their notes in a pop-up menu generated by selecting the my notes icon. The notes are saved on the CD-ROM or in network memory, depending on the form of the vehicle parts monitoring system 100.

The user inserts data in the my notes column 399 that is sufficiently large to contain the most detailed repair/replacement notes that may be encountered, e.g., 250 characters. The icon changes as data is inserted in the field. For example, in one embodiment, the icon becomes a little pen with some scribbled notes to indicate that some person (e.g., the present or prior owner, a service person, etc.) has inserted a note. As the user scrolls through thousands of parts, the icon indicates parts about which some information has been entered. Thus, the vehicle parts monitoring system 100 provides a recorded history of parts and assemblies.

A user who bought a car from an automobile manufacturer might type, for example, that a certain part (such as a drive shaft) was treated in a specific manner such as being painted black with a certain paint to meet certain rules. Another input may be that the engine was repaired with the part provided by a certain service center, with this part number, on a certain date. These notes are especially useful if somebody does their own vehicle care or has done something that was different from a typical repair. Records of this type would be useful for the owner or subsequent owners. In this manner, a prospective purchaser could determine exactly what maintenance has been done on a vehicle. This addition of repair notes in the my note column 399 of the vehicle parts monitoring system 100 could satisfy the maintenance logbook required for airplanes, helicopters and other vehicles by regulation.

When an owner restores a vehicle at a restoration shop, the more the owner knows about the authenticity of the parts in the vehicle, the more valuable the vehicle may be when sold. The next person that buys the vehicle would like to know that the present owner or service person took the time, expense, and effort to make repairs to the vehicle to comply with specifications, or to make the vehicle operate at its best.

The repair shops could use a tool like the vehicle parts monitoring system 100 to keep track of every single part that was inserted, or every operation that was performed, on the vehicle. The use of the pop-up window generated by selecting the my notes column 399 icon allows for such repair records to be kept. The repair shop or owner could print out an original/replaced/repaired parts list based on data stored in the relational database (i.e., memory 106). When a car is sold or restored, the vehicle parts monitoring system 100 would still keep track of all the parts, and would retain the descriptions of significant repairs. The entire history of the maintenance of a vehicle can therefore be included in the vehicle parts monitoring system 100.

When a vehicle is sold, the vehicle parts monitoring system 100 can be used to inventory the present state of the parts in that vehicle. The user can click on any one of the parts of the vehicle parts monitoring system 100 to determine whether the part is original, replaced, or repaired. If replaced or repaired, the vehicle parts monitoring system indicates such information as the part number, type, age, and who did the repair work, and all additional information that is stored within the vehicle parts monitoring system 100. This type of maintenance history information is extremely important both in typical vehicle maintenance and in vehicle restoration. The vehicle parts monitoring system 100 can be used to of track the entire maintenance of the vehicle as well as provide a resource for parts information.

Because the vehicle part monitoring system 100 includes the part number of, e.g., the engine, a repair person can access the data on the engine that they are working on to find out the identity and history of that engine. When a person is checking the part number of a large part or assembly that includes a large number of parts the person can use the vehicle parts monitoring system 100 to keep track of each part or assembly. As soon as one part is determined to be authentic for such an assembly, the person continues on to the next part. Thus, the vehicle parts monitoring system 100 can be used as a repair tool for the whole industry for these engines. The vehicle parts monitoring system 100 is useful for a dealer, a vehicle racer, a vehicle enthusiast, a vehicle or parts manufacturer, a repair shop, or an owner. And the vehicle parts monitoring system 100 becomes more important as more parts are repaired or replaced in a given vehicle. For example, when a user accesses the vehicle parts monitoring system 100, they will have information relating to many engines, parts, and/or vehicles. If one of these engines has been superseded, the user would have information indicating that it would be better to buy the redesigned engine, not the discontinued engine.

What happens in a couple of years when the owner has to have the engine or part replaced when it is time to get a major repair such as a valve job? The vehicle parts monitoring system 100 provides to the owner or service person information about whether a part is discontinued. This sort of information is extremely difficult to obtain without the vehicle parts monitoring system 100. Even information published in a manual or electronic catalog a year or six months ago is likely to be out of date, partially complete, or a challenge to obtain.

Certain embodiments of the vehicle parts monitoring system 100 allow the user to go on the Internet and access updated parts information. The vehicle parts monitoring system 100 is capable of providing information about any part or assembly. Even though the engines or other parts went out of circulation, 20 years from now 500 engines may be included in that vehicle parts monitoring system 100. In one embodiment, information on the CD-ROM can be updated with current part information by installing updates that can be accessed over the Internet. These application and the CD-ROM can build a process that allows the parts information to be quickly updated. An Internet bulletin service can be provided wherein users are notified of update information. Alternatively, the user can be provided with access to a remote network server that is continually updated, as appropriate.

While the embodiment of GUI display 114 has been applied to parts of automobiles, it is envisioned that similar systems can be applied to aircraft, boats, trucks, or any such vehicle. FIG. 4 shows one embodiment of the GUI display 114 of the vehicle parts monitoring system 100 relating to vehicle assembly. In this case, an engine is used as an example, rather than an entire vehicle as shown in the FIG. 3 embodiment of GUI display 114. It is to be emphasized that the columns included in the relational database parts display window 122 of the vehicle parts monitoring system 100 in FIG. 4 are identical to those shown in FIG. 3. For example, the columns included in the GUI display 114 include the user selection column 370, the category column 372, the system/group column 374, the part assembly column 376, the part name column 378, the part/detailed description column 380, the manufacturing column 390, the original equipment manufacturer (OEM) number column 392, the industry reference number column 394, the interchangeability column 396, the industry note column 398, and the my notes column 399. However, in place of the vehicle window 116 as shown in the embodiment of FIG. 3, this embodiment of the vehicle parts monitoring system 100 includes an assembly window 116 that includes a picture of an assembly (e.g., the engine). As such, the vehicle parts monitoring system 100 in the embodiment as shown in FIG. 4 will display the parts of the engine, instead of the parts of the entire vehicle. This is mirrored by the fact that the drive train is listed in all rows of the category column 372 in the FIG. 4 embodiment. In addition, the engine is listed in all rows of the system/group column 374. Therefore, the parts included in the relational database parts display window 122 in the FIG. 4 embodiment are limited strictly to engine parts. By comparison, the parts listed in the relational database parts display window 122 in the FIG. 3 embodiment include all of the parts of the vehicle.

In another embodiment of the vehicle parts monitoring system 100, not shown, that is devoted to displaying parts for the engine, one or both of the category column and the system/group column may be omitted. An advantage of including both of these columns in the FIG. 4 embodiment is to provide a certain degree of interuseability between the embodiment of vehicle parts monitoring system as shown in FIG. 3, and assembly parts monitoring system as shown in FIG. 4. For example, the user of the FIG. 3 embodiment becomes accustomed to viewing all the individual columns on the screen. It may be confusing, particularly to those individuals who frequently switch between a vehicle parts monitoring system and an assembly parts monitoring system, to have multiple columns in the latter.

In one embodiment, the vehicle parts monitoring system 100 is produced using CAD/CAM technology. CAD/CAM technology is commonly used in more recent vehicle construction. For example, the Boeing 777 jetliner represents the first major aircraft that was entirely designed and constructed using CAD/CAM technology, and the major automakers also use CAD/CAM technology. From the CAD/CAM drawings, electronic, computerized versions of blueprints, diagrams and electronic dealer information are provided. The CAD/CAM data/information could be received in electronic format to be stored on the CD-ROM 112. Optical character recognition programs could also be used so that the text received in the CAD/CAM CD-ROM can be searched. Thus, the vehicle parts monitoring system 100 could be built more quickly than any system involving manual data entry.

The vehicle parts monitoring system 100 can display CAD/CAM drawings over the GUI display 114. In one embodiment, a user can select the diagrams/tables selection button 322 shown in FIG. 3, and will be prompted with a pop-up window showing the selections of CAD/CAM drawings. By selecting one of the options, the CAD/CAM drawing fills the display screen.

The vehicle parts monitoring system 100 also captures assembly specifications from actual assembly manuals, repair shop manuals, and service manuals from vehicle manufacturers and parts manufacturers. Notes on assembly drawings are referred to in the industry as engineering comments. An example of an engineering comment on an assembly specification may be to position the center of a prescribed clamp ½″ to 1/16″ from the end of the tie rod for a particular year/make/model of vehicle. A user cannot find engineering comments in part catalogs or at parts suppliers (e.g., Pep Boys). A user can go to a dealership and buy a part, but there is no way that the user can determine the assembly specification information about that part. If a vehicle owner is going to install (or have installed) a particular part on a vehicle, the vehicle owner would likely prefer to use compatible procedures to those used when the vehicle was built. This limits any mistakes and is reliable and is made to engineering specifications. The vehicle parts monitoring system 100 thus can capture all of these engineering notes.

In one embodiment, the manufacturer would provide the vehicle parts monitoring system 100 to the purchaser of a vehicle (e.g., a CD-ROM would come in the glove compartment of the vehicle, which the new owner could insert in their home computer). There is a high probability that people who buy a high end, performance, or other specialty vehicle, will also want to buy accessories such as floor mats or roof racks. Purchasers of standard and economy vehicles also may desire to buy such authentic parts or at least have access to information about authentic parts relating to their vehicles. When the new owner installs the CD-ROM relating to the new vehicle, the billboard window 118 of the GUI display 114 can be used by the owner to access the Internet web site of the vehicle or parts manufacturer (provided the user has an Internet connection). The new owner might not even have previously known about the web sites, but the vehicle parts monitoring system 100 takes them there. Thus, the billboard window 118 of the vehicle parts monitoring system allows the user to access the manufacturer's web site so that the owner can determine the correct location to buy authentic parts and accessories over the Internet. The CD-ROM relating to the vehicle including the vehicle parts monitoring system 100 can travel along with the vehicle (e.g., be stored in a car, ship, truck, etc.), so that the information can be accessed at remote locations and/or in the case of emergencies.

The vehicle parts monitoring system 100 also supports billing. For example, assume that a military helicopter is damaged and is located at a remote location, e.g., Diego Garcia. The service personnel are at such a location that they are not able to dial the Internet, but they do have a computer and they need repair or replacement parts. The service personnel can use the embodiment of vehicle parts monitoring system shown in FIG. 1, and insert the CD-ROM (including the information for the vehicle parts monitoring system 100) into the computer 102. The information relating to the required helicopter parts is then accessed, including the blueprints and the diagrams. The service personnel can find exactly what part is needed, and order the part if it is available by phone. If the part is not available, the service personnel may have sufficient parts information to perhaps fashion a replacement part, or identify related parts from similar vehicles. The service personnel can then type a note in the pop-up window accessed from the my notes column 399 precisely describing the repair (the note is stored on the write-to-storage portion of the CD-ROM). When the helicopter is taken out of battle, for example, it goes back for repairs in a real repair shop. The vehicle parts monitoring system 100 thus contains an accurate record of what repairs were done in battle to get the helicopter up and running. There can be no mistakes because the repair data is captured right in the vehicle parts monitoring system 100. And the serial number of the parts stored on the CD would be the serial number that matches the part installed in the helicopter.

The vehicle parts monitoring system 100 could, in effect, go everywhere the vehicle goes. The vehicle parts monitoring system 100 would be protected, and would have a tremendous amount of support for documenting all types of repairs. All the data of the vehicle parts monitoring system 100 can be accessed by a user quickly, and the data is effectively displayed.

Assume the alternative, i.e., that a user has to look for parts information using prior electronic cataloging systems or manually looking through a parts catalog for a product. For manual catalogs, searching for parts is time-consuming and requires considerable cross-referencing. For electronic databases, the user typically has to drill down and drill through the Internet, and may eventually lose their way in a myriad of computer databases. The user of certain electronic vehicle parts cataloging systems may wind up at some remote electronic location not even close to where they started where they wish to be. The user has to start over again. So the user has to come back and start the search over again and access the web site again. The user loses their place, though, and it takes time to get the information. By comparison, in the vehicle parts monitoring system, a user can access multiple sequential windows simultaneously because all the information for a single part can be simultaneously accessed and displayed.

In the embodiment of the vehicle parts monitoring system 100 shown in FIGS. 1 and 2, the user may go off-line to a certain extent because the user clicks on an icon to go to a pop-up window. The information is actually stored in the records in the memory 106. Records for accessing catalog databases tend to be long. The size of the records in the vehicle parts monitoring system 100 is relatively small because so the information is accessed by the window-pops that allows the user to stay on the line. The links between associated parts provide for quick access for all sites relating to a specific link while transferring a relatively small amount of data. The user can therefore access all the reports on the part or assembly while transferring limited quantities of data. All the information relating to the part is included in the single row (and pop-up window accessed from that row). The user never has to leave the GUI display window 114 to access information about a particular part.

The vehicle parts monitoring system 100 can be considered as a reverse engineering reverse cataloging tool. In this disclosure, the phrase “reverse engineering” or “reverse cataloging” refers to the user being provided access to the data, assembly drawings, components, part descriptions, engineering specifications, or any other information used by engineers during the typical manufacturing process of a specific part or assembly. You take the engine and you reverse engineer the catalog data of the part number of every single component and piece of manufacturing history. The vehicle parts monitoring system 100 takes vehicle all the information relating to a vehicle, reverse engineers the catalog data, and loads the data in the web site or onto the CD-ROM. This process can be repeated for each year, make and model of vehicle. The present invention represents the first time the industry has reverse parts catalog engineering. This process works for major components (e.g., engines) as well as the more minor parts in vehicles.

Certain embodiments of the vehicle parts monitoring system 100 can also be used as a tool to reverse-engineer/catalog a large number of parts as shown in the embodiment of assembly parts monitoring system shown in FIG. 4. The assembly parts monitoring system shown in FIG. 4 can be considered as one embodiment (e.g., a subset) of a vehicle parts monitoring system. All the information relating to a prescribed engine, or multiple engines, can be stored on a CD-ROM or accessed from a server over the Internet. The user can load all this information from the CD-ROM onto the web site. Consider all the manufacturing information that can be captured in a form to be quickly accessed using present technology. A distinct vehicle parts manufacturing system could be provided for all the vehicles through all of the years, based upon available parts information.

The vehicle parts monitoring system 100 includes a billboard window 118. As a specific part is highlighted, the vehicle manufacturer (e.g., GM, Toyota, Boeing) as well as a link to the web page of the manufacturer of the highlighted part is displayed. When an end user orders a part, e.g., by clicking on the part, icons linked to the web pages for the respective part manufacturer and vehicle manufacturer are displayed in the billboard window 118. The user can thus obtain information about the manufacturers of the vehicle and/or part. The user can order parts from the original manufacturer. Links to alternative suppliers of the selected part can also be provided in certain embodiments within the billboard window 118.

Assume that certain users of vehicle parts monitoring system limits the ability of a user to assemble a car because the data present in existing catalogs, engineering drawing, and specifications may be inaccurate. A quality assurance step can be provided in certain embodiments of the vehicle parts monitoring system. The quality assurance step provides the equivalent of proofreading information in columns making sure that all of the things in this column adhere to certain standards and that there is a list of twelve columns and the standards that they should adhere to, like data entry operators have to adhere to standards as they are entering data. If there is inconsistent data, then the vehicle parts monitoring system can indicate the inconsistency, or can select on of the values as being the correct value automatically (e.g. select the value from the most reliable source). The quality assurance step is just the way of cleaning the data before the computer can process it, and the quality assurance step may be considered as basically a filtering process. An overall process of inserting data in the vehicle parts monitoring system would involve a first person, or group of people, getting the data and entering it into memory. A second person then performs quality assurance on the product, is that list completed projects by using the product itself. The tool allows the quality assurance processor to quickly sort/search for part details and quickly fix the problem detected by the processor. A printed report of parts provides the ability to select specific parts for review. The printed report unlocks all data on the part record, including data contained within icons, and displays the entire part information in a viewable area, separated from additional parts by a solid line. Quality assurance can thus be applied across industry manufacturers (e.g., Ford, GM, Toyota could use the same QA system). A user can quickly locate parts in the application using one format compared with separate formats from the different manufacturers.

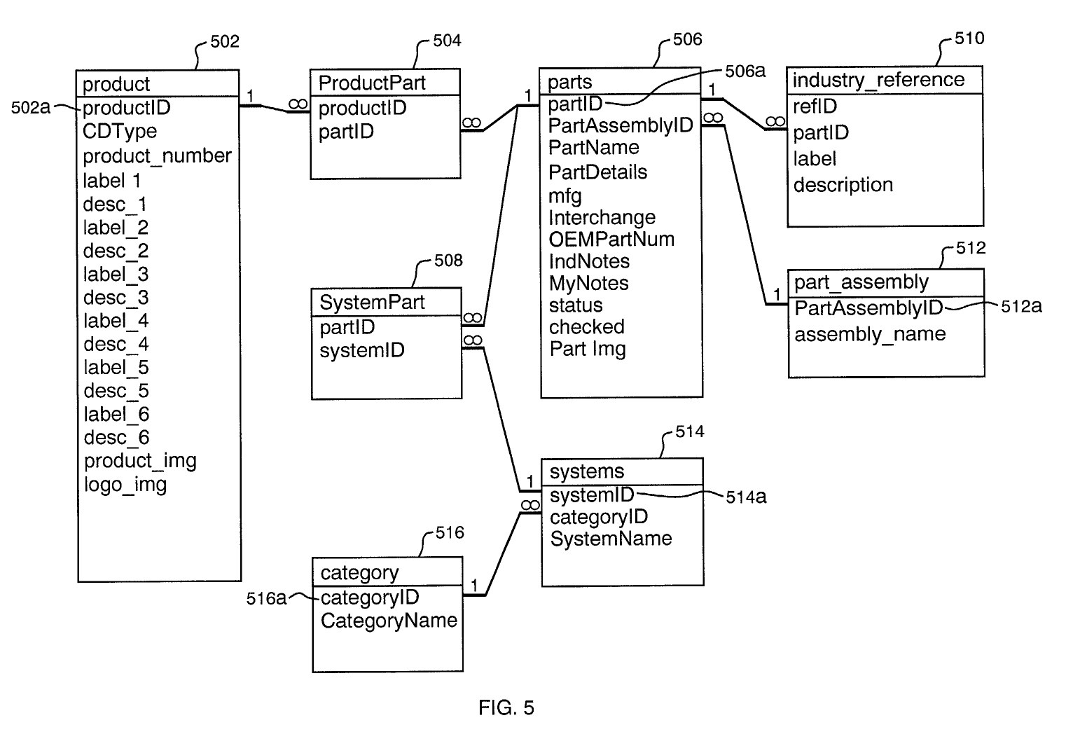

FIG. 5 shows one embodiment of a data structure diagram for the database included in the vehicle parts monitoring system. It is preferred to use a relational database, which relies on tables, for example, for each vehicle. The relational database of FIG. 5 includes multiple tables with entries like similar to your view. The parts are then cross-referenced to other tables in a diagram until they all link together. There is a list of categories that can be provided into the table. This table represents a data structure that is stored in memory.

One embodiment of the vehicle parts monitoring system relational tables 500 shown in FIG. 5. The vehicle parts monitoring system relational table 500 includes a product table 502, product part table 504, a parts table 506, a system part table 508, an industry reference table 510, a part assembly table 512, a systems table 514, and a category table 516. Each of the above tables includes, as known in relational database terminology, a primary key, and a multiple secondary key. Each primary key is indicated in the respective table by appending the letter “A” following the reference character pertaining to the table. For example, in the product table 502, the primary key is referenced as the product ID 502A. Certain tables do not have the primary key indicated. For example, the primary key of the product table 502 is product I.D. The primary key for the parts table is parts I.D. 506A. The primary key for the part assembly table 512 is part assembly ID 512A. The primary key for the system table is system I.D. is 514A. The primary key for the category table 516 is category I.D. 516A.

In the embodiment of product table 502 shown in FIG. 5, there are multiple secondary key entries including CD type, product number, label and description, product image, and logo image. The product I.D. 502A, there is a primary key to the product table, has one too many relationship between the product table 502 and the product parts table 504. The part I.D. key, that is the primary key 506A for the parts table 506, has a one minute relationship between the parts table 506 and the product parts table 504. The part I.D. key 506A has one too many relationship between the parts table 506 and the system part table 508. The system I.D. key 514A has one too many relationship between the system table 514 and the system part table 508. That category I.D. key 516A has a one too many relationship between the category table 516 and the systems table 514. The parts assembly I.D. key 512A has a one minute relationship between the part assembly table 512 and the parts table 506. The part I.D. key 506A has a one minute relationship between the parts table 506 and the industry reference table 510. Secondary keys in the product parts table include product I.D. and part I.D. Secondary keys in the parts table include part assembly I.D., part name, part detail, interchangeability, original equipment manufacturer (OEM) part number, IND notes, my notes, status, checked, and part image. The secondary keys in the systems table 514 includes category I.D. and system name. The secondary keys in the industry reference table include reference I.D., part I.D., label, and description. The secondary keys in the part assembly table 512 includes the assembly name.

An advantage in using the relational tables 500 as shown in FIG. 5, is that queries, as known in relational databases, can be applied to obtain a variety of information arranged in different formats and different tables, for example. As such, if it is desired to supply a slightly modified version of the vehicle parts monitoring system from that shown in FIGS. 3 and/or 4, then the query can be modified to produce different data output. In addition, the displayed columns on the vehicle parts monitoring system can be modified to suit near any changes in the query.

The vehicle parts monitoring system may be considered as a view generated by the relational database. In the database, certain fields are linked together by different keys or indexes. If the user clicks on the parts web page of the vehicle manufacturer (e.g., GM Restoration Parts™ or Mr. Goodwrench™ the user hovers over the billboard window 118. A text pop-up window will open querying the user whether they wish to access the web site of the vehicle manufacturer. A screen may be provided warning the user that the vehicle parts monitoring system not responsible for the connection to the vehicle manufacturer web site, and that the user needs to connect to the Internet first, and then click to access the website.

In an embodiment, the billboard window or area 118 of the vehicle parts monitoring system 100 can hot link the user to the web page of the vehicle or parts manufacturer using the engine CD. The vehicle parts monitoring system 100 is just taking the customer into the GM store. In one embodiment, the vehicle part monitoring system is configured as a restoration part store that uses the Internet. The user can select the part by click on “Order By Car Number” and toggle back over to find a specific part that referenced by a specific part number. The user then selects the part. The vehicle parts monitoring system will respond by indicating either that no parts are available because they don't have access to that particular part, or displaying the particulars relating to ordering the part on a screen allowing the user to order that part.

The vehicle parts monitoring system allows for reverse part engineering of each particular year/make/model part. Parts are the largest market in the auto industry. The major American, European, and Asian automakers have been moving into the aftermarket parts industry very rapidly recently. The vehicle parts monitoring system can be configured to identify the authentic parts of the vehicle that are/were necessary to build the vehicle. The user of the vehicle parts monitoring system thus has access to the parts, assembly drawings, and specifications that were used to build a prescribed vehicle. In certain embodiments the part suppliers only have so many parts in inventor in our database right now. The part suppliers can use the information from the vehicle parts monitoring system to find suppliers for the remaining parts that are not in stock. The missing parts can be ordered so that the consumers will be able to buy all the necessary parts.

The vehicle parts monitoring system thus represents a major revenue opportunity for the authentic parts and vehicle manufacturer since the users are provided with information relating to and/or directed to the web sites of the parts and vehicle manufacturers. If an owner or service person buys a non-authentic, pirate, or used part, the vehicle and original parts manufacturers typically do not realize any profit. The vehicle parts monitoring system thus provides an opportunity to identify those parts that need to be ordered or manufactured. Many vehicle and parts manufacturers don't know the identity of authentic parts for certain vehicles, especially if the vehicle is relatively old and many parts are discontinued or superceded. Many vehicle and parts manufacturers don't have tools to define many of the authentic parts of their own vehicles prior to the vehicle parts monitoring system.

The parts and vehicle manufacturers can provide to a vehicle manufacture or parts supplier a rough calculation of the numbers of authentic or substitute parts currently available. The vehicle and parts manufacturer, however, don't know if a certain part supplied to a part supplier has been sold. The vehicle or part manufacturer, based on prior history, can then start producing the most commonly ordered and/or the lowest stocked parts. Alternatively, the parts or vehicle manufacturer can find a supplier to produce the desired parts. The users (vehicle owners, suppliers, manufacturers, service persons) using the vehicle parts monitoring system can determine which authentic parts are available, and from whom they are available. Actual parts in a vehicle can be compared to the authentic parts as derived in a vehicle parts inventory system. Using the vehicle parts monitoring system, the vehicle or manufacturer or parts manufacturer can also determine the most currently ordered parts.

In one alternate embodiment, the web site of the part manufacturer can be accessed by clicking on the billboard window 118. The user can then toggle over and type the part number in by hand. Assume a user would like to buy a specified part. The user selects the OEM Number from the OEM number column 392, and the user double-clicks over the part number. The user selects the part number to select the part. A user can thus request a part from the vehicle and/or parts manufacturer using the Internet. The user of the vehicle parts identification system can therefore add the part therefore add to their shopping cart at the vehicle or parts manufacturer web site. The field associated with the part may be highlighted or underlined, indicating the computer is loading that part number into the users computer (inventor) clipboard. The windowing (GUI) mechanism in performing this operation is the same as doing a copy or a cut and paste. The OEM number is then sent to the original part manufacturer or vehicle manufacturer to purchase the correct part.

To order a part from the vehicle or parts manufacturer in another embodiment of vehicle parts monitoring system, the user toggles over to the billboard, select paste at the vehicle or parts, manufacturer web page, and orders the part. In a further embodiment, if the user orders the part from the vehicle or parts manufacturer, the vehicle parts monitoring system can default to the original manufacturer part store. The user then clicks the part to purchase the part. Perhaps the user would like the opportunity to go to another parts supplier store from the original vehicle or parts manufacturer. The user can go to the web store of another parts supplier or manufacturer if they desire. Now the user has the ability when he's in that alternate vendor store to use the information that is now stored in his clipboard. In other words, regardless of where the user is in the Internet, the user can access the part number from the vehicle part monitoring system in his clipboard and can cut and paste the accurate description and part number as desired. This cut and paste feature allows the user to compare the cost of an authentic part compared to a non-authentic part, and order the part from a variety of parts vendors, including the original part manufacturer. Even if the user decides to purchase the authentic part, they will have considerable information to allow the end user to determine the suitability of a non-authentic part. The vehicle parts monitoring system thus makes it easier for the user to order parts.

It is thus possible for a user to order parts on line. In the embodiment shown in FIG. 2, the vehicle parts monitoring system is acting as a client server application. The vehicle parts monitoring system could respond with such dialogue as “found this part at this location for this price”, “didn't find that one”, etc. The user could then insert the found parts in the Internet shopping cart to purchase the parts. You bought the part, the transaction was indicated on the vehicle part monitoring system. As the user logs off the Internet, the transaction is kept track of in the memory of the client server application.

The graphic user interface (GUI) 114 is considered to be the front end of the vehicle parts monitoring system 100. The different panes or views in the GUI illustrate different types of information. The particular vehicle or large assembly that the vehicle parts monitoring system is accessing is displayed in a vehicle window or parts window. Since the vehicle or part is in the window frame the confusion to the user as to which part is being accessed is limited. One embodiment of the billboard area is illustrated that displays the list of manufacturers or partners associated with that assembly, or part. Regardless of whether the user has access to a workstation, a personal computer, or a laptop, the relevant vehicle information is provided in photo, specifications, diagrams, and/or manufacturing history format of any particular part. The different formats are provided depending on the particulars of the selected part. The vehicle parts monitoring system thus provides the information that the user needs to make the decision as to purchase any part, and the relevant information to install the part. The user goes to the single line in the vehicle parts monitoring system relating to the specific part, selects the part, purchases the part, and the vehicle parts monitoring system keeps track of the purchase. The user then continues to the next step, part. When the user log off the Internet, all the information about purchased parts is maintained in the user computer or network. The picture in the vehicle parts or vehicle window changes based on the vehicle or part that the user is viewing.

As an example, when a user clicks on an engine icon, (multiple different engines with different pictures can be stored in a single CD) he can view some of these brochures on those engines. The user then selects one of the engines. The vehicle or part including the part highlighted in the vehicle parts monitoring system is displayed on the billboard. An image of that engine will pop up in one of the windows and be maintained as the user is viewing data relating to that engine as shown in the embodiment in FIG. 4. The picture of the engine will thus be in one window and all of the parts while the manufacturing history information relating to that engine is displayed in another window. Now, assume that the user wishes to view parts associated with another vehicle or major assembly. The user, for example, clicks on the truck conversion engine and the vehicle parts monitoring system displays the part number of that engine in the GUI. If the user selects an alternate engine, the picture of the engine changes suitably in the window. Data relating to the new engine is then loaded in the computer.

Another aspect of the vehicle parts monitoring system is that vehicle owners, service persons, or enthusiasts are interested in how their particular vehicle is built and what goes into these vehicles. Consider how much more enjoyable a high school auto-shop class would be if the students were provided with the engineering specifications and drawings of the car from the vehicle parts monitoring system. For example, data could be obtained relating to the part of concern using electronic sorting techniques. The different images and text of the part could be displayed on a screen in different ways. For example, different portions of the engine could be viewed. A student would thus be taught about and learn that particular engine using the most up-to-date information. A CD of the vehicle parts monitoring system could then be provided to the student. The student takes the CD home, inserts their own notes in the my notes column 399 relating to certain parts. The student could then print out a report to keeps track of the project. Based on the report, the student could perform the associated repair on the actual vehicle. In effect, the repair being done on the vehicle mirrors the part descriptions and specifications of the vehicle parts monitoring system. The vehicle parts monitoring system is thus a tremendous learning tool. The learning tool is another example of how the product can be used in the auto industry.

The vehicle parts monitoring system could be used as a recruiting tool describing the vehicles of that particular branch of armed service. For example, the vehicle parts monitoring system can also be used in the aviation or naval industry to teach their maintenance, personnel pilots, etc. the components associated with an aircraft. The vehicle parts monitoring system provides an excellent mechanism for such people to understand the structure and operation of the parts in their particular aircraft.

While the principles of the invention have been described above in connection with the specific apparatus and associated method, it is to be clearly understood that this description is made only by way of example and not as a limitation on the scope of the invention.

1. A graphical user interface comprising:
a tabular display; and
a tabular database, a user can access information from the tabular database, the tabular database is configured to store data relating to a vehicle system/group category table, a vehicle part category table, and a unique vehicle part identifier table, wherein the vehicle part category table is linked to the vehicle system/group category table and the unique vehicle part identifier table is linked to the vehicle part category table, and wherein data for a prescribed part corresponding to the vehicle system/group category table, the vehicle part category table, and the unique vehicle part identifier table is displayed within the tabular display along a single row.

2. The graphical user interface of claim 1, wherein the tabular database further comprises a parts description table.

3. The graphical user interface of claim 1, wherein the tabular database further comprises an original equipment manufacturer (OEM) number table.

4. The graphical user interface of claim 1, wherein the tabular database further comprises a status field table.

5. The graphical user interface of claim 1, wherein the tabular database further comprises an indicator table.

6. The graphical user interface of claim 1, wherein the tabular database further comprises an industry reference number table.

7. The graphical user interface of claim 1, wherein the tabular database further comprises an interchangeability table.

8. The graphical user interface of claim 1, wherein the tabular database further comprises a part description table.

9. The graphical user interface of claim 1, further comprising a billboard portion wherein a user of the graphical user interface can access a web site of the producer of the part.

10. The graphical user interface of claim 1, wherein the tabular database is located in the user's computer.

11. The graphical user interface of claim 1, wherein the data for the tabular database is stored in a CD-ROM for use in the user's computer.

12. The graphical user interface of claim 1, wherein the tabular database is located in a network to which the user's computer is connected.

13. The graphical user interface of claim 12, wherein the network is the Internet.

14. The graphical user interface of claim 1, further comprising a vehicle pictorial display that displays the vehicle relating to the tabular database.

15. The graphical user interface of claim 14, further comprising a vehicle selection portion that selects the vehicle being displayed in the vehicle display.

16. The graphical user interface of claim 15, wherein the contents of the tabular database changes accordingly as a user selects a different vehicle to display in the vehicle display using the vehicle selection portion

17. A data structure configured to store data, the data structure comprising:
a tabular database, the tabular database including:
a vehicle system/group category table,
a vehicle part category table, and
a unique vehicle part identifier table, wherein the vehicle part category table is linked to the vehicle system/group category table and the unique vehicle part identifier table is linked to the vehicle part category table.

18. The data structure of claim 17, wherein the tabular database further comprises a part description table.

19. The data structure of claim 17, wherein the tabular database further comprises a original equipment manufacturer (OEM) table.

20. The data structure of claim 17, wherein the tabular database further comprises a status field table.

21. The data structure of claim 17, wherein the tabular database further comprises an indicator table.

22. The data structure of claim 17, wherein the tabular database further comprises an industry reference number table.

23. The data structure of claim 17, wherein the tabular database further comprises an interchangeability table.

24. The data structure of claim 17, wherein the tabular database further comprises a part description table.

25. The data structure of claim 17, further comprising a billboard portion wherein a user can access a web site of the producer of the part.

26. The data structure of claim 17, wherein the tabular database is located in the users computer.

27. The data structure of claim 17, wherein the data for the tabular database is stored in a CD-ROM included for use in the user's computer.

28. The data structure of claim 17, wherein the tabular database is located in a network to which the user's computer is connected.

29. The data structure of claim 28, wherein the network is the Internet.

30. The data structure of claim 17, further comprising a vehicle pictorial display that displays the vehicle relating to the tabular database.

31. The data structure of claim 30, further comprising a vehicle selection portion that selects the vehicle being displayed in the vehicle display.

32. The data structure of claim 31, wherein the contents of the tabular database change accordingly as a user selects a different vehicle to display in the vehicle display using the vehicle selection portion.

33. A method of building a catalog database configured to store catalog data, the method comprising:
creating the catalog database, the catalog database comprising a vehicle system/group category table, a vehicle part category table, and a unique vehicle part identifier table, wherein the vehicle part category table is linked to the vehicle system/group category table and the unique vehicle part identifier table is linked to the vehicle part category table;
ranking the reliability of data from each one of the plurality of catalogs;
determining where there is an inconsistency from different ones of the plurality of catalogs in the vehicle system/group category table;
inputting data from the plurality of catalogs into the vehicle system/group category table; and
discarding that data originating from one of the plurality of catalog with a relatively low reliability that is inconsistent with other data from another one of the plurality of catalog with a relatively high reliability.

34. The method of building a database as set forth in claim 33, further comprising allowing a human operator to select one from the plurality of inconsistent catalogs in the vehicle system/group category table to input.

35. A method of determining the identity of authentic vehicle parts for a target vehicle using a catalog database comprising:
establishing the fields for the catalog database, the catalog database comprising a vehicle system/group category table and a unique vehicle part identifier table, wherein the unique vehicle part identifier table is linked to the vehicle system/group category table;
querying the vehicle system and/or group to obtain a list of vehicle parts included in that vehicle system and/or group; and
storing the list of vehicle parts in the catalog database in response to query.

36. The method of claim 35, wherein substantially all of the vehicle parts are included in the catalog database.

37. The method of claim 36, wherein reverse engineering the parts of the target vehicle is allowed.

38. The method of claim 35, wherein the querying the vehicle system and/or group includes obtaining a list of supercede vehicle parts and superseding vehicle parts.

39. The method of claim 38, wherein the list of vehicle parts in the catalog database includes storing the list of superseding vehicle parts and discarding the list of superceded vehicle parts.

40. A database that describes the identity of authentic vehicle parts for a vehicle parts monitoring system, the database comprising:
a first column that includes a vehicle system/group category description;
a second column that includes a part description as described by the original part manufacturer; and
a third field that describes a unique vehicle part identifier table part/detailed description column that more distinctly describes the part description than the part description.
